(19) United States
(12) Patent Application Publication
(10) Pub. No.: US 2026/0359872 A1
(43) Pub. Date: Nov. 12, 2026

(54) GENERATION OF SUMMARY DESCRIPTIONS USING LLMs

(71) Applicant: Amadeus S.A.S., Biot (FR)

(72) Inventors: Gilbert BADARO, Nice (FR); Christophe BLAYA, La Roquette-sur-Siagne (FR); Utkarsh TREHAN, Nice (FR); Adina Faye BONDOC, Biot (FR)

(21) Appl. No.: 19/635,869

(22) Filed: Apr. 1, 2026

(30) Foreign Application Priority Data
May 7, 2025 (DE) 202025102519.1

(51) Int. Cl. G06Q 30/0601; G06F 16/34; G06F 40/295; G06N 3/045

(52) U.S. Cl. CPC G06Q 30/0623; G06F 16/345; G06F 40/295; G06N 3/045

(57) ABSTRACT

Methods, computer systems, and computer program products for generating summary descriptions. A computing system retrieves a description comprising a first description part consisting of structured data and a second description part consisting of unstructured data and identifies textual named entities in the second description part using a Named Entity Recognition, NER, based algorithm for merging the identified textual named entities into the structured data. Computing system generates, based on the structured data including the textual named entities, a plurality of summary descriptions, wherein each summary description is generated using a Large Language Model, LLM, being distinct from another LLM-based algorithms from a plurality of LLMs. Computing system determines a score for each one of the plurality of summary descriptions, selects one of the plurality of LLMs based on the score, and generates further summary descriptions based on further descriptions using the selected LLM.

### FIELD OF THE INVENTION

The present disclosure relates to information technology methods and systems, in particular, generating summary descriptions.

### BACKGROUND

In the rapidly evolving field of data processing, the ability to efficiently handle and analyse both structured and unstructured data has become increasingly important. Structured data, which is highly organized and easily searchable, often exists in formats like databases and spreadsheets. In contrast, unstructured data, such as text documents, emails, and social media posts, lacks a predefined format, making it more challenging to process and analyse.

The advent of advanced language models has revolutionized the way of processing and generating text-based data. Large Language Models (LLMs) have demonstrated remarkable capabilities in understanding and generating human-like text, making them suitable tools for tasks such as summarization, translation, and content creation. As different models may excel in different aspects such as accuracy, speed, and contextual understanding, a suitable LLM has to be selected. Additionally, ensuring the quality and reliability of the generated content is critical, as issues like hallucinations and bias can significantly impact the usefulness of the summaries. As organizations increasingly rely on data-driven insights, there is a growing need for sophisticated methods that can seamlessly integrate structured and unstructured data, leverage the strengths of various LLMs, and ensure the generation of high-quality, reliable summaries.

Attention is drawn to improving the operating mechanisms to generate summary descriptions using LLMs.

### SUMMARY

According to a first aspect, a computing system retrieves a description comprising a first description part consisting of structured data and a second description part consisting of unstructured data and identifies textual named entities in the second description part using a Named Entity Recognition, NER, based algorithm for merging the identified textual named entities into the structured data. Computing system generates, based on the structured data including the textual named entities, a plurality of summary descriptions, wherein each summary description is generated using a Large Language Model, LLM, being distinct from another LLM-based algorithms from a plurality of LLMs. Computing system determines a score for each one of the plurality of summary descriptions, selects one of the plurality of LLMs based on the score; and generates further summary descriptions based on further descriptions using the selected LLM.

According to a second aspect, a computing system for storing log files is provided, the computing system being arranged to execute the methods as described herein.

Finally, a computer program is presented that comprises instructions which, when the program is executed by a computer, cause the computer to carry out the methods described herein.

Further refinements are set forth by the dependent claims.

These and other objects, embodiments and advantages will become readily apparent to those skilled in the art from the following detailed description of the embodiments having reference to the attached figures, the invention not being limited to any particular embodiments.

### BRIEF DESCRIPTION OF THE DRAWINGS

Aspects and examples of the present disclosure are described with reference to the following figures, in which:

FIG. 1 illustrates a illustrates a computing system generating summary descriptions as described herein.

FIG. 2 shows a flow chart for the generation of summary descriptions as described herein.

FIG. 3 illustrates a further example for the generation of summary descriptions as described herein.

FIG. 4 depicts the scoring of the generated summary description.

FIG. 5 shows the generation of a human generated reference text.

FIG. 6 illustrates sub-scores as described herein.

FIG. 7 further illustrates sub-scores as described herein.

FIG. 8 further illustrates sub-scores as described herein.

FIG. 9 depicts an exemplarily summery description as described herein.

FIG. 10 shows a further flow chart for the generation of summary descriptions as described herein.

FIG. 11 depicts an internal structure of a computation engine which to host a computer unit.

### DETAILED DESCRIPTION

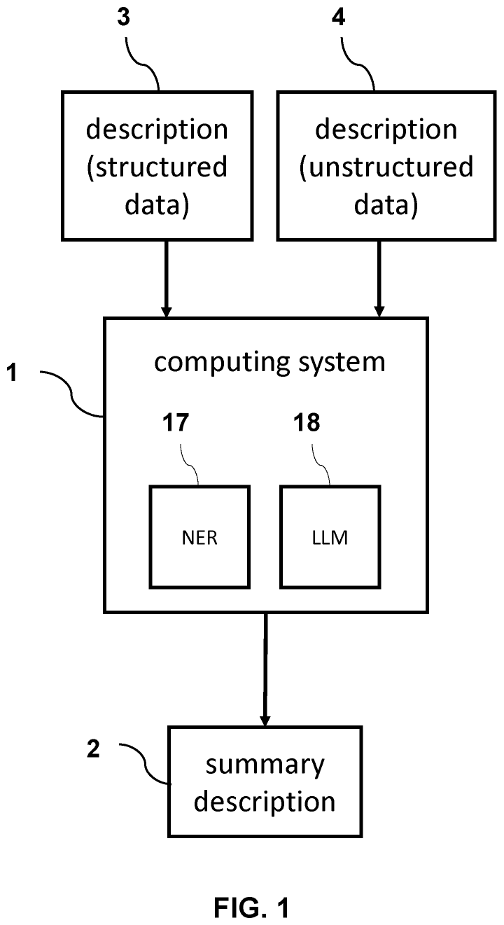

The present disclosure relates to methodologies for generating summary descriptions 2 at a computing system 1, as shown in FIG. 1. Computing system 1 receives a first description consisting of structured data 3 and a second description 4 consisting of unstructured data 4. Computing system may apply, as described in detail below, algorithms based on Named Entity Recognition 17 and Large Language Models 18 for the generation of summary descriptions 2.

Computing system 1 is located anywhere and includes at least one individual computing machine that may be part of a computing cloud, as well as, in some embodiments, of a more powerful machine such as a database application server, a distributed database system comprising multiple interconnected machines, data centres etc. In some embodiments, computing system 1 may act as a server towards one or more client, processing and serving requests for generation of summaries from one or more clients.

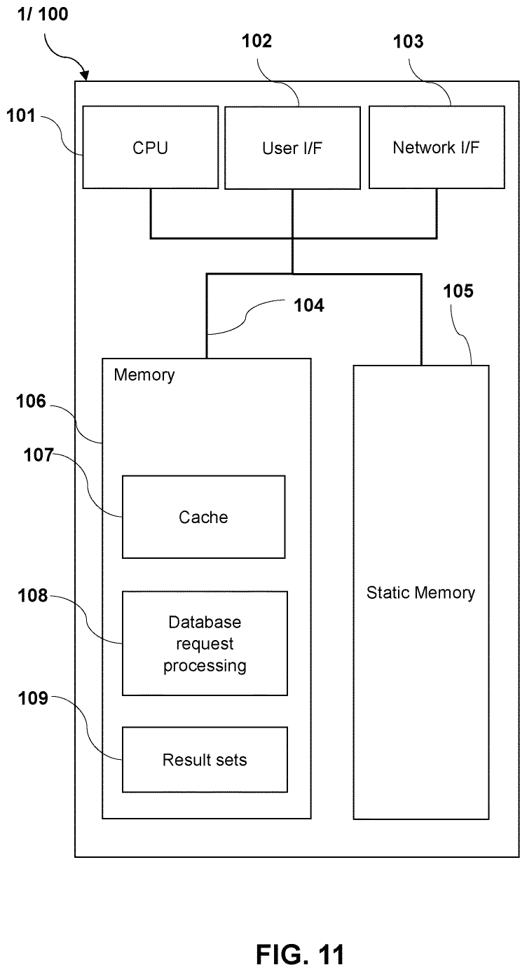

Computing system 1 may be constituted of several hardware machines, such as personal computers as well as, in some embodiments, of more powerful machines such as database application servers, distributed database systems comprising multiple interconnected ma-chines, data centres etc., depending on performance requirements. Computing system 1 is embodied e.g. as stationary or mobile hardware machine comprising computing machine 100 as illustrated in FIG. 11 and/or as specialized system such as an embedded system arranged for a particular technical purpose, and/or as software component running on a general or specialized computing hardware machine (such as a web server and web clients).

In some embodiments, summary descriptions may be comprised of one or more description fields, with said description fields comprising textual content of one or more data formats.

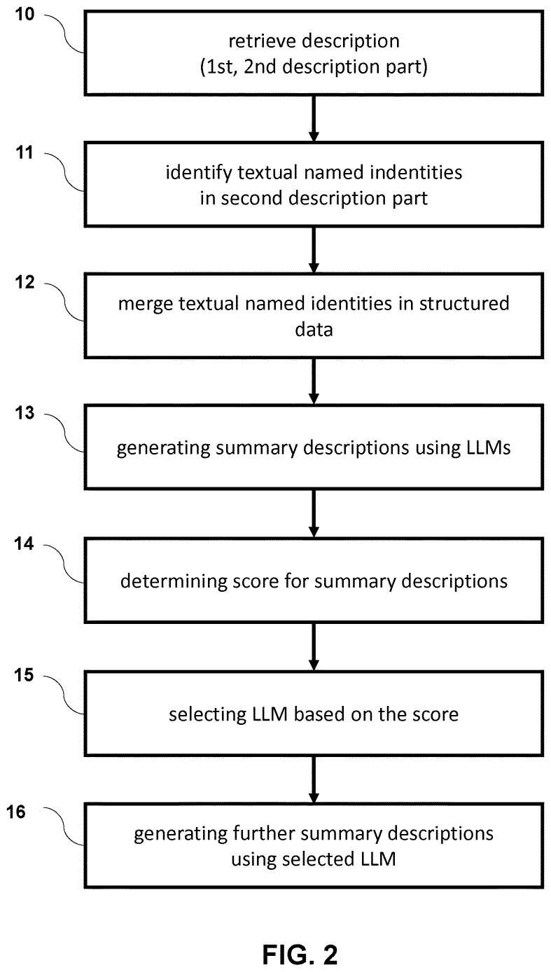

FIG. 2 shows a flow chart for the generation of summary descriptions. Computing system 1 retrieves 10 a description comprising a first description part 3 consisting of structured data and a second description part 4 consisting of unstructured data and identifies 11 textual named entities in the second description part 4 using a Named Entity Recognition, NER, based algorithm for merging 12 the identified textual named entities into the structured data. Computing system 1 generates 13, based on the structured data including the textual named entities, a plurality of summary descriptions, wherein each summary description is generated using a Large Language Model, LLM, being distinct from another LLM-based algorithms from a plurality of LLMs. Computing system 1 determines 14 a score for each one of the plurality of summary descriptions, selects 15 one of the plurality of LLMs based on the score; and generates 16 further summary descriptions based on further descriptions using the selected LLM.

The methodology as provided ensures that, by merging of textual named entities into structured data, the structured data is made comprehensive and reflective of the information contained within the unstructured data, serving as basis for generating accurate and informative summary descriptions reflecting the information given in both, the original structured data and the unstructured data.

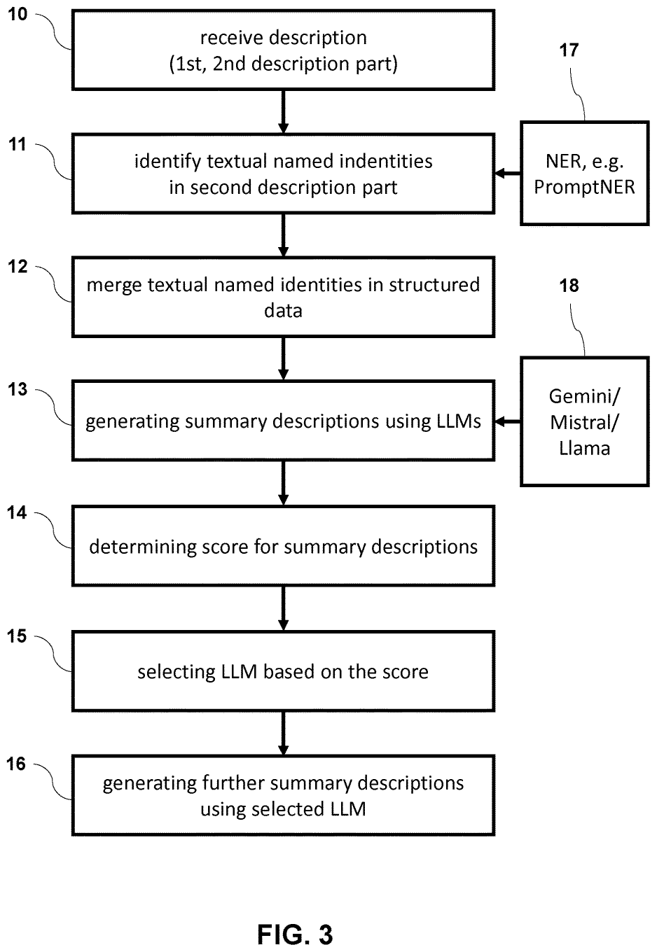

In some embodiments and as also shown in FIG. 3, the Named Entity Recognition based algorithm may comprise Prompt Locating and Typing for Named Entity Recognition, PromptNER 17. The use of a PromptNER-algorithm enables the precise identification of relevant textual named entities contained within the unstructured text, which may be utilized in subsequent data processing steps. The integration of these identified textual named entities into the structured data may enrich the data set, providing a more comprehensive basis for generating summary descriptions. This ensures that the structured data is sufficiently detailed and accurate, thereby improving the quality of the summary descriptions generated in later stages of the process and thereby enhancing the accuracy and efficiency of the entity recognition process.

In some embodiments and as shown in FIG. 3 too, the LLM 18 is based on a Gemini- and/or Mistral- and/or Llama-model 18. These LLM-models may contribute, by providing different capabilities or strengths, to the diversity and richness of the generated summary description. In some embodiments, each summary description may be generated using a specific LLM (Gemini, Mistral, or Llama). The selection of a particular LLM for generating a summary description may be influenced by factors such as the subject the summary descriptions are addressing, the language of the second description parts comprising the unstructured data/text elements. In some embodiments, generating summary descriptions may not only involve the application of LLMs but may also involve the integration of implicit components and actions. For instance, the structured data, enriched with textual named entities, may need to be pre-processed or formatted in a manner that is compatible with the LLMs. Additionally, the generation of summary descriptions may involve iterative refinement or optimization processes to ensure that the summaries are coherent, relevant, and aligned with the intended purpose of the data processing method.

Llama models, in 7B and 65B parameter versions, were first introduced in 2023 revolutionizing the use of only public datasets and outperforming GPT-3 on most benchmarks. Its most recent release, Llama 3 in 8B and 70B, builds upon its predecessors by incorporating Grouped Query Attention (GQA) and expanding its training data and vocabulary.

In some embodiments, Llama models may comprise enhanced security measures for both inputs and outputs. Its accompanying instruction model may make use of supervised fine-tuning (SFT) and direct preference optimization (DPO) for fine-tuning. This model has proven to be competitive compared to state-of-the-art models such as GPT-4 in terms of output quality. A more efficient version of Llama, being fine-tuned using Quantized Low-Rank Adapters (QLoRA), has achieved a tenfold increase in context size from 8K to 80K tokens in just 8 hours on an 80 GB GPU, while preserving performance.

Founded in 2023, Mistral AI has released its own language model Mistral 7B which also makes use of GQA like Llama but this time coupled with Sliding Window Attention (SWA) to lessen inference costs and allow for the processing of longer sequences. It surpasses Llama 2, the previous leading open-source 13B model, across all benchmarks. Additionally, its instruction-tuned version also outperforms its Llama 2 counterpart. In some embodiments, the instruct model may have three updates in which the second update removed the use of SWA and increased the context window from 8K to 32K. Building on these, the third update further increased the vocabulary size to 32,768 and provided support for function calling alongside a new tokenizer.

Gemini, Google's large language model (LLM), is a family of multimodal AI models designed to process multiple modalities or types of data, including audio, images, software code, text and video. Gemini has been trained on a massive corpus of multilingual and multimodal data sets. It employs a transformer model, a neural network architecture that Google itself introduced in 2017. Gemma is the newest family of open-source models provided by Google, based on their bigger multimodal model Gemini. It is notably smaller than other models, offering 2B and 7B parameter versions initially, followed by 2B, 9B, and 27B options in its second release, Gemma 2. Both models incorporate enhanced security features. Gemma 2 further advances by employing GQA and SWA, similar to Mistral 7B, but in an alternating pattern across layers, coupled with logit soft-capping which improves training by constraining logits within a specific range. Gemma 2 utilizes knowledge distillation. In some embodiments, the instruct version of Gemma 2 may be fine-tuned using a mix of SFT and Reinforcement Learning from Human Feedback and on a mix of synthetic and human-generated datasets.

In some embodiments, the capabilities of LLMs for specific tasks may be extended through the refinement of prompts, or instructions, instead of fine-tuning or retraining the model (prompt engineering). Prompt engineering may be composed of five basic components: instructions, task-specific context, relevant examples, history, and the current request.

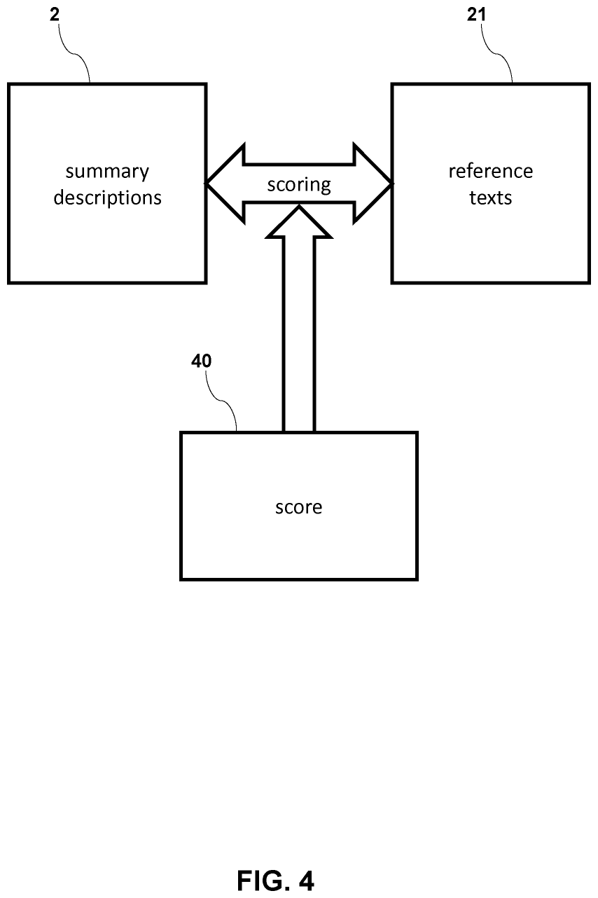

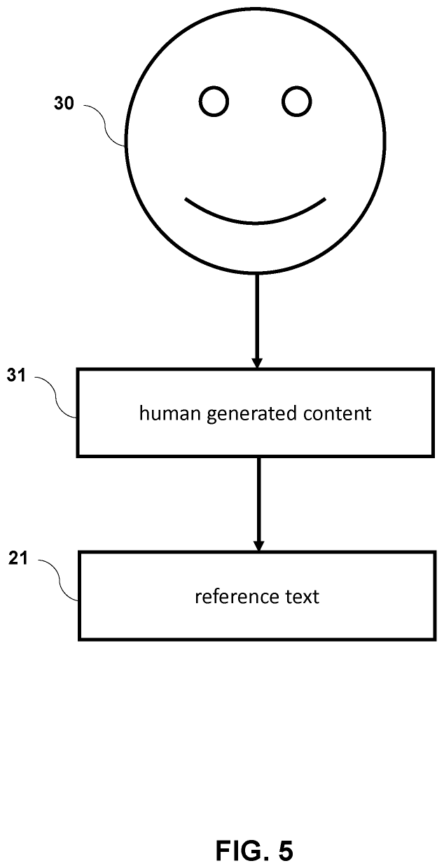

In some embodiments and as shown in FIG. 4, the plurality of summary descriptions 2 are scored against one or more reference texts 21 by applying a score 40 as described in detail below. This enables assessing the degree of deviation from a standard or template reference summary description. In some embodiments, and as shown in FIG. 5 the one or more reference texts 21 represent human generated content 31, i.e. generated by a human 30. This enables assessing the degree of deviation from a human-generated reference summary description, as human generated texts usually represent the most accurate and most easily readable and understandable description of a subject, with the quality of human generated texts exceeding, at least for now, the quality of machine- or AI-generated corresponding texts.

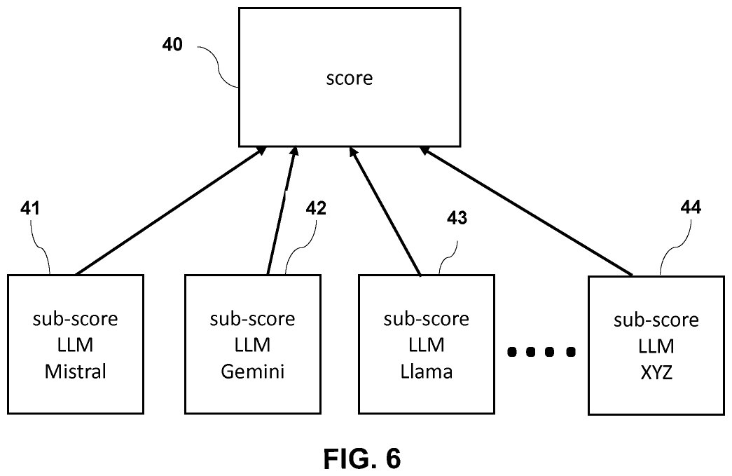

In some embodiments and as shown in FIG. 6, the score 40 is a composite score comprising multiple sub-scores, wherein each of the sub-scores indicates a performance measure and/or quality measure of the corresponding LLM, such as e.g. Mistral 41 or Gemini 42 or Llama 43 or any other LLM-model 44 which generates the summary description associated with the score. These sub-scores enable a detailed evaluation of the summary descriptions, allowing for a comprehensive performance evaluation of the LLMs, such as Mistral 41, Gemini 42 or Llama 43. The selected LLM, may then be used to generate further summary descriptions based on additional descriptions. This ensures that the most effective LLM is utilized, potentially enhancing the quality and relevance of the generated summaries. In summary, the determination of these sub-scores enable the selection of the most suitable LLM for generating further summary descriptions, ensuring that the chosen model aligns with the desired quality and performance criteria.

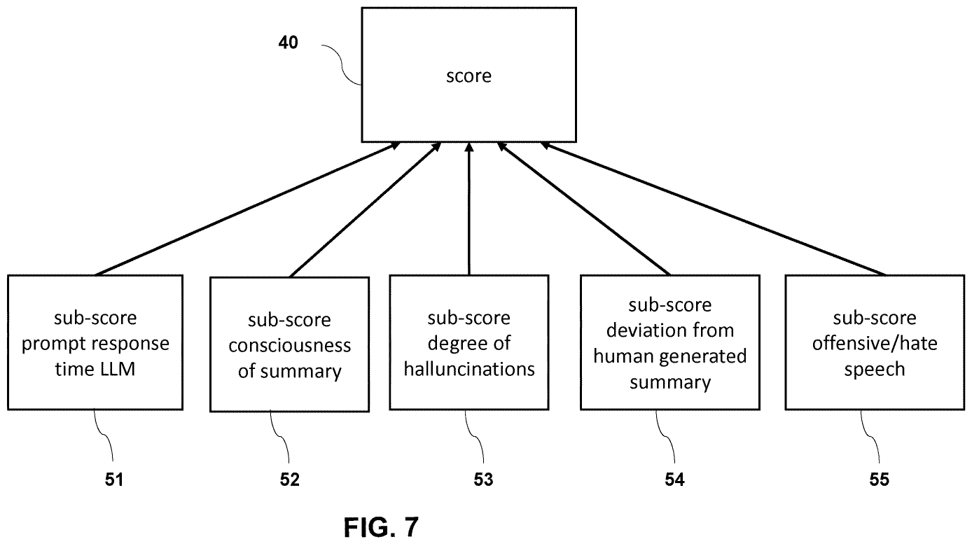

In some embodiments and as shown in FIG. 7, the score 40 may comprise at least one of a sub-score indicating a prompt response time of the LLM 51, a sub-score indicating conciseness of the summary description 52, a sub-score indicating a degree of hallucinations 53 included in the summary description, a sub-score indicating a degree of deviating 54 from a human-generated reference summary description, and a sub-score indicating a degree of offensive and/or hate speech 55 reflected in the summary description. AI hallucination, as an example, may have significant consequences for real-world applications. AI hallucination problems may also contribute to the spread of misinformation. One significant source of hallucination in machine learning algorithms is input bias. If an AI model is trained on a dataset comprising biased or unrepresentative data, it may hallucinate patterns or features that reflect these biases.

In some embodiments, the hallucination sub-score 53 may be based on Vectara's Hughes Hallucination Evaluation Model, HHEM-1.0-Open, which was built on top of the Google's flan-t5-base model. A hallucination score ranging from 0 (complete hallucination) to 1 (factual accuracy) is assigned. A threshold of 0.5 was used to classify outputs as hallucinated or factual.

In some embodiments, the toxicity sub-score may assess toxicity by a pre-trained hate speech classification model through the toxicity module of Hugging-Face, with a default threshold of 0.5. Developed by UNHCR in collaboration with Copenhagen Business School, this Robustly Optimized Encoder Representations from Transformers Pretraining Approach (RoBERTa)-based model was fine-tuned on 12 abusive language datasets and employs multi-label classification: Normal, Offensive, and Hate speech. Using this, two different scores were derived to provide 0 to 1 scores for offensive language and hate speech separately.

The methodology as shown in FIG. 7 therefore enables a further detailed evaluation of the scores to identify the LLM that best meets the desired criteria for summary generation, with respect to e.g. misinformation.

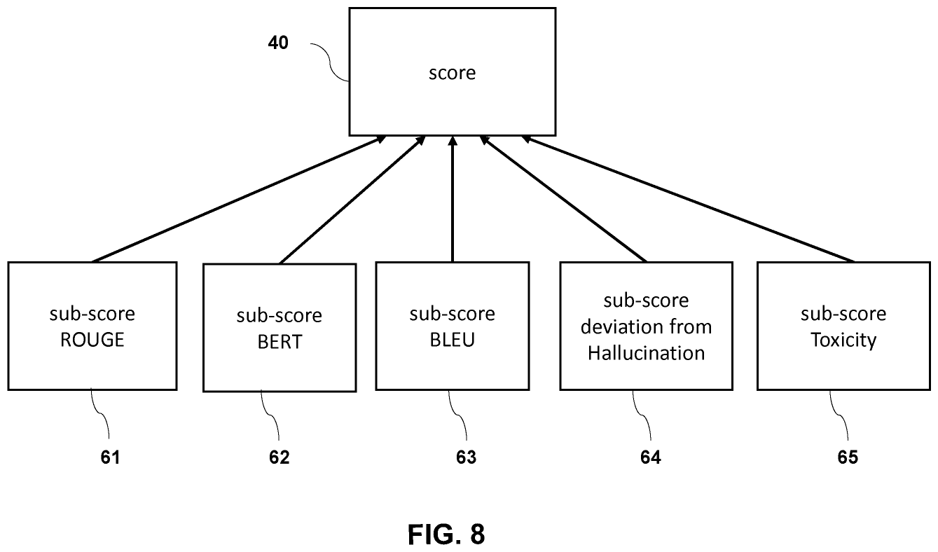

In some embodiments and as shown in FIG. 8, the score 40 comprises at least one of a Recall-Oriented Understudy for Gisting Evaluation (ROUGE) 61, sub-score, the Bidirectional Encoder Representations from Transformers (BERT) 62, sub-score, a Bilingual Evaluation Understudy (BLEU) 63, sub-score, a Hallucination sub-score 64 and a Toxicity sub-score 65.

As an example, the metrics employed by ROUGE compare an automatically produced summary or translation against a reference or a set of references (human-produced) summary or translation. ROUGE metrics range between 0 and 1, with higher scores indicating higher similarity between the automatically produced summary and the reference. The ROUGE-2 score, ranging from 0 (no overlap) to 1 (identical), measure output similarity to the reference text. The following equation shows the its computation, with the denominator as the total number of contiguous sequences of two words (gram2) in the reference summary, and numerator counting the number of matches there are with the sequence, S.

$$\frac{{\sum }_{Sε \{ ReferenceSummaries \}} {\sum }_{g r a m 2 ε S} {Count}_{match} ( gram 2 )}{{\sum }_{Sε \{ ReferenceSummaries \}} {\sum }_{g r a m 2 ε S} Count ( gram 2 )}$$

BERT learns to represent text as a sequence of vectors using self-supervised learning. It uses the encoder-only transformer architecture. BERT dramatically improved the state-of-the-art for large language models. BERT is trained by masked token prediction and next sentence prediction. As a result of this training process, BERT learns contextual, latent representations of tokens in their context. BLEU is an algorithm for evaluating the quality of text which has been machine-translated from one natural language to another. Quality is considered to be the correspondence between a machine's output and that of a human. BLEU's output is always a number between 0 and 1. This value indicates how similar the candidate text is to the reference texts, with values closer to 1 representing more similar texts.

Including sub-scores based on the aforementioned LLM-models further enhances the LLM-model selection process.

In some embodiments, the score may comprise a unified score, representing the performance of model and prompt combinations with respect to business priorities such as efficiency, compliance, and accuracy. In some embodiments, a unified score may be used to determine the overall performance of a prompt-model combination across many properties and iterations.

A unified score may determine the overall performance of a prompt-model combination across many properties and iterations and may be based on the average inference time, compliance to the word count restrictions, hallucination, and dissimilarity. An additive model as shown in the following equation may be based on the following metrics: inference time, word count, hallucination, and ROUGE/ROUGE-2:

UnifiedScore=PercentileRank_{1/AvgTime}+Percent_{WordsInRange}−Percent_{Hallucinations}−AvgDissimilarity

The first component PercentileRank_{1/AvgTime} is the percentile of the model-prompt combination with respect to the inverse of the average prompt time. Percentile ranks were used for comparison across different combinations due to the absence of a fixed time benchmark and the inverse was taken to prioritize faster timings. The second positive component Percent_{WordsInRange} is the percent of outputs wherein the word count of generated summary descriptions are within 100 words, to show proper compliance to the prompt instruction. For the negative components, Percent_{Hallucinations} is the percentage of outputs that are hallucinations, and AvgDissimilarity the average dissimilarity. This metric effectively identifies significantly different or unrelated generated descriptions and is thus a negative component for the overall score. Since each component is expected to be between 0 and 1, the expected values of this Unified Score are between −2 and 2, with higher values signifying better performance.

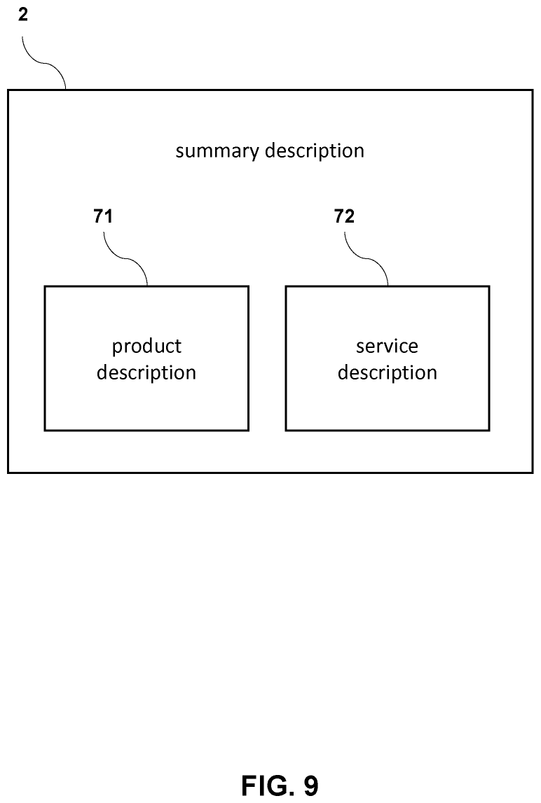

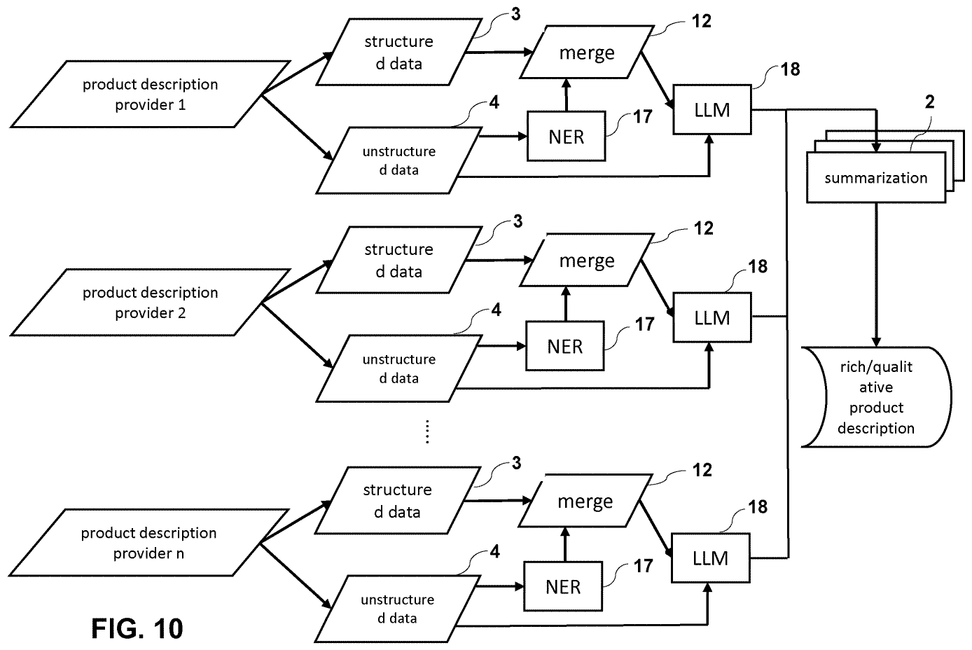

In some embodiments and as shown in FIG. 9, the summary description 2 comprises a product 71 and/or service description 72. In embodiments, the service description 72 may relate to product description, or to hotel and travel services, as described in detail in the following example relating to FIG. 10.

FIG. 10 illustrates an example for the methodologies as described within this application. A description may be retrieved 10 by the computing system 1, which may include a first description part consisting of structured data and a second description part consisting of unstructured data. The description may relate to, as shown in FIG. 10, to e.g. product descriptions, but also to hotel descriptions, travel service descriptions etc. The computing system 1 may execute the methodologies to handle both structured and unstructured data, thereby facilitating data acquisition. The retrieval 10 of the description may serve the purpose of enabling subsequent data processing steps, which may involve the integration and analysis of both structured and unstructured data components. The computing system 1 may be designed to efficiently manage and process the retrieved data, ensuring that both structured and unstructured elements are appropriately handled to support the generation of summary descriptions 2. The methodologies may be implemented through a computer program product, which may store program code on a computer-readable medium, allowing the method to be executed when run by a computer. This implementation may ensure that the methodologies are accessible and executable across various computing platforms, thereby enhancing its applicability and utility in diverse data processing scenarios.

The methodologies may involve the identification 11 of textual named entities within the second description part, which consists of unstructured data. This identification 11 may be achieved through the application of a Named Entity Recognition (NER) based algorithm 17. The NER algorithm may be designed to recognize and extract named entities from the unstructured data 4 received at computing unit 1 as shown in FIGS. 1, 10, thereby facilitating the integration of these entities into the structured data 3. Extracted named entities may e.g. relate to hotel services. Hotel data may be collected from two sources: Global Distribution Systems (GDS) and aggregators like Booking.com and Expedia. GDS data originates directly from hotels, including hotel chains. The extracted data may follow the OpenTravel Alliance format for Hotel descriptions (OTA_HotelDescriptiveInfoRS) as established in 2003. As an example for a text representing unstructured data 4, the following hotel description may be given:

“Within a stay at hotel HotelName in Challis, you'll be next to a golf course, just a 3-minute walk from Challis City Park and 7 minutes by foot from The Church of Jesus Christ of Latter Day Saints. This golf motel is 1 mi (1.6 km) from Land of the Yankee Fork State Park and 1.5 mi (2.4 km) from Challis Golf Course.”

Extracted name entities may e.g. comprise:
HotelName: name of the hotel;
HotelCode: unique identifier combining letters and numbers, representing hotel, data provider, and country information;
ChainCode: two letters representing the Hotel Chain or Aggregator code, can be derived as the first two letters in the HotelCode;
CountryCode: two letters representing the Country, conforming to ISO 3166 alpha-2 code standards;
AddressLine: specific address of the hotel, mostly in freeform text;
CityName: name of the city;
Awards: hotel classification based on different award systems, such as:
   AwardProvider: awarding body of a certain hotel award;
   AwardRating: rating received by the hotel;
   RatingSymbol: unit of measure of award rating, usually in stars;
RefPoints: reference points near the hotel property, such as
   RefCode: unique code for the reference point;
   RefName: name of the reference point;
   Distance: numerical value of distance to property;
   UnitofMeasureCode: code representing the unit of measure of the distance
   provided (1-miles, [2,3]-km);
   Direction: direction of the point of interest with respect to the property;
   ToFrom: indicates if direction specified is to or from the property;
   IndexPointCode: reference point category;
   TransportationCode: codes of transport to reach the reference point;
   Instructions: instructions to reach the reference point;
   PrimaryIndicator: if it is a primary reference.

Referring to the example hotel description as given above, the following structured data may be extracted from the unstructured data 4 by using a NER 17.

```
{
  ″HotelName″: ″<HotelName>″,
  ″HotelAdjectives″: [
    ″golf″
  ],
  ″Location″: {
    ″City″: ″Challis″,
    ″Country″: ″USA″
  },
  ″Dining″: [
    ″Restaurant″
  ″NearbypointsofInterest″: {
    ″Name″: ″Challis Golf Course″,
    ″Type″: ″GolfCourse″,
    ″Distance″: ″1.5 mi (2,4 km)″
  }
}
```

An example for structured data 3 received at computing system 1 as shown in FIGS. 1, 10 and in which the structured data extracted from the unstructured data 4 (as shown above) is to be merged 12 may be as follows:

```
{
  ″HotelName″: ″<HotelName>:″,
  ″AddressLine″: ″<Address>″,
  ″City″: ″Challis″,
  ″Country″: ″United States of America″,
  ″Awards″: [
    {
      ″Rating″: ″2 Stars″
      ″Provider″: ″Local Star Rating″
    }
  ],
  ″NearbyPointsofinterest″: [
    {
      ″Name″: ″Challis city Park″,
      ″Distance″: ″0.2 km″
    },
    {
      ″Name″: ″The Church of Jesus Christ of Latter Day Saints″,
      ″Distance″: ″0.6 km″
    },
    {
      ″Name″: ″Land of the Yankee Fork State Park″,
      ″Distance″: ″1.6 km″
    },
    {
      ″Name″; ″Challis Golf Course″,
      ″Distance″: ″2.3 km″
    },
    {
      ″Name″: ″Salmon River″,
      ″Distance″: ″3.0 km″
    },
    {
      ″Name″: ″Challis Hot Springs″,
      ″Distance″: ″14.2 km″
    },
    {
      ″Name″: ″Bayhorse GhostTown″,
      ″Distance″: ″22.0 km″
    }
  ]
}
```

Once structured data is extracted from e.g. the XM/L files, the hotel name, country, city, address, awards, and reference points were included into one summary description 2 for each HotelCode.

The algorithm may include a specific method known as Prompt Locating and Typing for Named Entity Recognition, or PromptNER 17, which may be employed to enhance the accuracy and efficiency of the entity recognition process. The use of such an algorithm may allow for the precise identification of relevant entities, which can then be utilized in subsequent data processing steps. The integration of these identified entities into the structured data may enrich the data set, providing a more comprehensive basis for generating summary descriptions 2. This step may be for ensuring that the structured data is sufficiently detailed and accurate, thereby improving the quality of the summary descriptions generated in later stages of the process.

Also, NER-algorithms may offer insights beyond what can be found in structured information. It may extract crucial details like e.g. hotel adjectives (e.g., “luxury,” “budget-friendly”), special offers (e.g., “free breakfast,” “spa discount”), target market (e.g., “families,” “business travellers”), and reference point types (e.g., “garden,” “museum”). Moreover, NER may identify reference points that can be regarded as the main points of interest, compared to just a list of reference points in the structured data, providing more relevant and curated information for the subsequent description generation.

As the methodologies as described herein may involve the merging 12 of identified textual named entities into the structured data 3, the structured data 3 is enriched by integrating the identified entities, which may have been recognized within the unstructured data 4 using a Named Entity Recognition (NER) based algorithm. This integration may facilitate subsequent data processing tasks, such as generating 13 summary descriptions 2. The enriched structured data may then be utilized in further steps to generate a plurality of summary descriptions, each potentially leveraging distinct Large Language Models (LLMs) 18 for diverse outputs. The merging of textual named entities into structured data may be a step in ensuring that the structured data is comprehensive and reflective of the information contained within the unstructured data.

The methodology may then generate 13 a plurality of summary descriptions 2 based on structured data that includes textual named entities, as shown in FIG. 10. This step may be in the overall method for data processing, as it may facilitate the creation of concise and informative summaries from the enriched structured data. The generation of these summary descriptions 2 may be achieved through the utilization of a Large Language Model (LLM) 18, which may be distinct from other LLM-based algorithms within a plurality of available LLMs. This distinction may allow for a diverse range of summary descriptions 2, each potentially offering unique insights or perspectives based on the specific LLM employed.

In the following, an example for a plurality of summary descriptions 2 is given in table 1, together with the LLMs (e.g. Mistral, Llama) used for the generation of these descriptions and a unified scoring.

TABLE 1
Example for a plurality of summary
descriptions generated with LLMs Mistral and Llama.

| Bottom | Model | Unified Score |
|---|---|---|
| 1 | Mistral v0.3 | −1.79 |
| 2 | Mistral v0.3 | −1.60 |
| 3 | Llama 3 | −0.63 |

Sample Outputs

| | |
|---|---|
| Bottom 1 | Experience the warmth of small-town hospitality at <Hotel Name>, nestled |
| | in charming Challis, USA. With cozy Standard Rooms (85pernight)and |
| | DelixeRooms(95 per night), this 2-star motel offers comfortable |
| | accommodations for couples and families. For larger groups, opt for the |
| | Family Suite ($110 per night). Indulge in hearty American cuisine at the on- |
| | site <Hotel Restaurant Name>, open for breakfast, lunch, and dinner. |
| | Located near Challis City Park, The Church of Jesus Christ of Latter Day |
| | Saints, Land of the Yankee Fork State Park, Challis Golf Course, Salmon |
| | River, Challis Hot Springs, and Bayhorse Ghost Town, <Hotel |
| | Name>provides easy access to local attractions. Transportation options |
| | include Friedman Memorial Airport (2.0 km), Challis Transit System |
| | (Monday-Friday, 8 AM-5 PM), and Enterprise Rent-A-Car in Challis, ID. |
| | Guests rave about the friendly staff, comfortable rooms, and excellent dining |
| | at the restaurant, earning an average rating of 4.5 out of 5. Book your stay |
| | today! |
| Bottom 2 | The <Hotel Name>(<Address>, CHALLIS, United States of America) offers |
| | Standard Rooms, Deluxe Rooms, and Suites, each equipped with air |
| | conditioning, a flat-screen TV, a coffee machine, a private bathroom, and |
| | free WiFi. Some rooms have a balcony with views of the mountain or |
| | garden. Dine at our on-site restaurant serving American cuisine. Breakfast, |
| | lunch, and dinner are available. Free parking is available on site. Challis |
| | Airport is 5.5 km away. We have an average rating of 4.5 stars out of 5 based |
| | on 100 reviews. Location Highlights: -Challis City Park: 0.2 km-The |
| | Church of Jesus Christ of Latter Day Saints: 0.6 km-Land of the Yankee |
| | Fork State Park: 1.6 km-Challis Golf Course: 2.3 km-Salmon River: 3 km- |
| | Challis Hot Springs: 14.2 km-Bayhorse Ghost Town: 22 km |
| Bottom 3 | Step into the rustic charm of <Hotel Name>, nestled in the heart of Challis, |
| | Idaho. This 2-star gem offers cozy rooms with comfortable beds, flat-screen |
| | TVs, and modern amenities. Start your day with a hearty breakfast at our on- |
| | site restaurant, serving up American classics with a twist. Take a stroll along |
| | the scenic Salmon River or explore the nearby Land of the Yankee Fork |
| | State Park. After a day of adventure, unwind by the fireplace or enjoy a drink |
| | at our bar. With its convenient location and warm hospitality, <Hotel |
| | Name>is the perfect base for exploring the stunning natural beauty of central |
| | Idaho. |

The methodologies as described may further elaborate on the characteristics of the LLMs 18 used. Each summary description may be generated using a specific LLM 18, which may be based on models such as Mistral 41, Gemini 42, Llama 43 or any other LLM 44. These models may provide different capabilities or strengths, thereby contributing to the diversity and richness of the generated summaries 2. The selection of a particular LLM for generating a summary description may be influenced by various factors, including the specific requirements such as the audience to which the generated summaries 2 are addressed for.

The process of generating summary descriptions 2 may not only involve the application of LLMs 18 but may also require the execution of additional methodologies. For instance, the structured data, enriched with textual named entities, may need to be pre-processed or formatted in a manner that is compatible with the LLMs. Additionally, the generation of summary descriptions 2 may comprise iterative refinement or optimization methodologies to ensure that the summaries are coherent, relevant, and aligned with the intended purpose of the methodologies as described herein.

A score for each of the plurality of summary descriptions may be determined 14. This may involve evaluating the quality of the summary descriptions 2 generated by different Large Language Models (LLMs) 18. The scoring may be based on a composite score that comprises multiple sub-scores, each reflecting a specific performance or quality measure of the LLM 18 that generated the summary description 2. These sub-scores may include metrics such as prompt response time, conciseness, the degree of hallucinations present in the summary, deviation from human-generated reference summaries, and the presence of offensive or hate speech. The scoring process may also involve comparing the summary descriptions 2 against one or more reference texts 21, which may represent human-generated content 31. This comparison may help in assessing the degree of deviation from a human-generated reference summary description. The composite score may include specific sub-scores like the Recall-Oriented Understudy for Gisting Evaluation (ROUGE) sub-score 61, the Bidirectional Encoder Representations from Transformers (BERT) sub-score 62, the Bilingual Evaluation Understudy (BLEU) sub-score 63, a Hallucination sub-score 64, and a Toxicity sub-score 65. These sub-scores may provide a detailed evaluation of the summary descriptions 2, allowing for a comprehensive performance evaluation of the LLMs 18. The determination of these scores may be for selecting the most suitable LLM 18 for generating further summary descriptions, ensuring that the chosen model aligns with the desired quality and performance criteria.

An example for scoring for each of the plurality of summary descriptions is given in table 2, showing the top combinations based on ROUGE-2 and unified score with a sample output and its metrics. Top combinations based on ROUGE-2 may favour the Chain-of-Density (CoD) prompt framework and original text descriptions, while those based on unified scores may prefer the Context, Objective, Style, Tone, Audience, and Response (CO-STAR) prompt framework and NER results in JSON format. For those based on ROUGE-2, only the top combination may demonstrate an exceptional hallucination score in the sample output. The other two combinations may have hallucination scores close to or below 0.5, indicating potential hallucinations in the generated content. Furthermore, the top combinations based on the unified score may demonstrate a more coherent flow and better balance between the hallucination score and ROUGE-2.

TABLE 2
Example for scoring for each of the plurality of summary descriptions

| Best Combination | | | | | |
|---|---|---|---|---|---|
| | | Unified | RO- | | Sample Output |
| Basis | Top | Score | GUE2 | Hallucination | Text |
| RO- | 1 | 0.47 | 0.50 | 0.98 | <Hotel Name>is a golf motel next to a |
| GUE2 | | | | | golf course. It's a 3-minute walk from |
| | | | | | Challis City Park, a 7-minute walk |
| | | | | | from The Church of Jesus Christ of |
| | | | | | Latter Day Saints, 1 mi (1.6 km) from |
| | | | | | Land of the Yankee Fork State Park, |
| | | | | | and 1.5 mi (2.4 mi) from Challis Golf |
| | | | | | Course. It has a restaurant. |
| | 2 | 0.53 | 0.48 | 0.52 | <Hotel Name>in Challis offers golf |
| | | | | | course access, onsite dining, and is |
| | | | | | within walking distance of Challis |
| | | | | | City Park (3-minute walk) and The |
| | | | | | Church of Jesus Christ of Latter Day |
| | | | | | Saints (7 minutes by foot). It's 1 mi |
| | | | | | from Land of the Yankee Fork State |
| | | | | | Park and 1.5 mi from Challis Golf |
| | | | | | Course. |
| | 3 | 0.40 | 0.43 | 0.45 | <Hotel Name>: golf course, |
| | | | | | restaurant. Near Challis City Park, The |
| | | | | | Church of Jesus Christ of Latter Day |
| | | | | | Saints, Land of the Yankee Fork State |
| | | | | | Park, and Challis Golf Course. |
| Unified | 1 | 1.10 | 0.14 | 0.97 | Escape to <Hotel Name>in Challis, |
| Score | | | | | USA. This charming golf-themed |
| | | | | | motel offers comfortable |
| | | | | | accommodations and on-site dining. |
| | | | | | Enjoy a delicious meal at our |
| | | | | | restaurant or tee off at the nearby |
| | | | | | Challis Golf Course, just 1.5 miles |
| | | | | | away. |
| | 2 | 1.07 | 0.13 | 0.99 | Escape to <Hotel Name>in Challis, |
| | | | | | USA. This charming motel offers |
| | | | | | comfortable rooms and convenient |
| | | | | | amenities. Enjoy delicious meals at |
| | | | | | our onsite restaurant or tee off at the |
| | | | | | nearby Challis Golf Course, just 1.5 |
| | | | | | miles away. Perfect for golf |
| | | | | | enthusiasts seeking a relaxing |
| | | | | | getaway. |
| | 3 | 1.05 | 0.12 | 0.96 | Escape to <Hotel Name>in Challis, |
| | | | | | USA! This charming motel offers |
| | | | | | comfortable rooms perfect for your |
| | | | | | golf getaway. Enjoy delicious meals at |
| | | | | | our onsite restaurant and tee off just |
| | | | | | 1.5 miles away at the scenic Challis |
| | | | | | Golf Course. Book your relaxing stay |
| | | | | | today! |

Further summary descriptions 2 may be generated based on additional descriptions using the selected LLMs 18 to generate e.g. rich and qualitative product and/or service descriptions, as shown in FIG. 10, e.g. hotel service descriptions. This may involve utilizing the capabilities of the chosen LLM 18 to produce new summaries that are informed by the previously determined scores and selections. The generation of these further summaries may be aimed at enhancing the breadth and depth of the content produced, potentially including product and/or service descriptions. The selected LLMs 18 may leverage its distinct algorithmic strengths to interpret and synthesize the additional descriptions into coherent and contextually relevant summaries. This step may serve to expand the range of summaries available, providing a more comprehensive set of descriptions that align with the intended use cases or requirements. The process may be iterative, allowing for continuous refinement and adaptation of the summaries as new descriptions are introduced and processed by the system.

In some embodiments, in order to visualized the entire methodology from XML extraction to the generation of summary descriptions 2, a simple user interface (UI) may be used based on e.g. Streamlit on Python. This UI may allow users to view generated descriptions 2 for a specific hotel. The original descriptions from all available providers may be displayed. Subsequently, non-hallucinated NER outputs may be shown to provide context for the description generation process, enabling users to view generated descriptions based on the NER outputs of each data provider. At the bottom of the UI, summarized description may be presented along with its ROUGE-2 and hallucination metrics. Additionally, users may explore different summarized descriptions and their corresponding metrics. Due to resource limitations and the batch processing nature of the prompt pipeline, all data and outputs may be preloaded, and the UI may serve primarily as a proof of concept.

FIG. 11 is a diagrammatic representation of the internal components of a computing machine 100 implementing the functionality of a computing system, such as computing platform 1. The computing machine 100 includes a set of instructions to cause the computing machine 100 to perform any of the methodologies discussed herein when executed by the computing machine 100. The computing machine 100 includes at least one processor 101, a main memory 106 and a network interface device 103 which communicate with each other via a bus 104. Optionally, the computing machine 100 may further include a static memory 105 and a disk-drive unit. A display, an alpha-numeric input device and a cursor control device may be provided as examples of user interface 102. The network interface device 103 connects the computing machine 100 implementing the user terminal 1 with the search platform 2.

Computing machine 100 includes a memory 106 such as main memory, random access memory (RAM) and/or any further volatile memory. The memory 106 may store temporary data and program data 107 to facilitate the functionality of the computing device 1, including program data to realize, by the computing unit 1, the receiving (activity 10) of one or more descriptions. In addition, the memory 106 may store temporary data and program data 107 to realize, by the computing platform 1, in an activity 11, the identification of textual named entities in the second description part using a Named Entity Recognition, NER, based algorithm for, in an activity 12, merging the identified textual named entities into the structured data. Further, the memory 106 may store temporary data and program data 107 to realize, by the computing platform 1, in an activity 13, the generation, based on the structured data including the textual named entities, a plurality of summary descriptions, wherein each summary description is generated using a Large Language Model, LLM, being distinct from another LLM-based algorithms from a plurality of LLMs, as well as, in activity 14, the determination of a score for each one of the plurality of summary descriptions, further, in an activity 15, the selection of one of the plurality of LLMs based on the score, and, in an activity 16, the generation of further summary descriptions based on further descriptions using the selected LLM.

A set of computer-executable instructions embodying any one, or all, of the methodologies described herein, resides completely, or at least partially, in or on a machine-readable storage medium, e.g., in the static memory 105 or, when loaded and being executed, in the main memory 106. For example, the instructions may include software processes implementing the search result processing functionality of the computing platform 1. The instructions may further be transmitted or received as a propagated signal via the Internet through the network interface device 103 or via the user interface 102. Communication within computing machine 100 is performed via a bus 104. Basic operation of the computing machine 100 is controlled by an operating system which is also located in the memory 106, the at least one processor 101 and/or the static memory 105.

In general, the routines executed to implement the embodiments, whether implemented as part of an operating system or a specific application, component, program, object, module or sequence of instructions, or even a subset thereof, may be referred to herein as “computer program code” or simply “program code”. Program code typically comprises computer-readable instructions that are resident at various times in various memory and storage devices in a computer and that, when read and executed by one or more processors in a computer, cause that computer to perform the operations necessary to execute operations and/or records embodying the various aspects of the embodiments of the invention. Computer-readable program instructions for carrying out operations of the embodiments of the invention may be, for example, assembly language or either source code or object code written in any combination of one or more programming languages.

In certain alternative embodiments, the functions and/or acts specified in the flowcharts, sequence diagrams, and/or block diagrams may be re-ordered, processed serially, and/or processed concurrently. Moreover, any of the flowcharts, sequence diagrams, and/or block diagrams may include more or fewer blocks than those illustrated consistent with embodiments and examples.

The terminology used herein is for the purpose of describing particular embodiments and examples, and is not intended to be limiting. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While a description of various embodiments has illustrated all of the inventions and while these embodiments have been described in considerable detail, it is not the intention to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details.

What is claimed is:

1. A computer-implemented method for data processing, the method comprising:
retrieving a description comprising a first description part consisting of structured data and a second description part consisting of unstructured data;
identifying textual named entities in the second description part using a Named Entity Recognition based algorithm;
merging the identified textual named entities into the structured data;
generating, based on the structured data including the textual named entities, a plurality of summary descriptions, wherein each summary description is generated using a Large Language Model (LLM) being distinct from another LLM-based algorithm from a plurality of LLMs;
determining a score for each one of the plurality of summary descriptions;
selecting one of the plurality of LLMs based on the score; and
generating further summary descriptions based on further descriptions using the selected LLM.

2. The method of claim 1 wherein the Named Entity Recognition based algorithm comprises Prompt Locating and Typing for Named Entity Recognition.

3. The method of claim 1 wherein the LLM is based on a Gemini-model and/or a Mistral-model and/or a Llama-model.

4. The method of claim 1 wherein the plurality of summary descriptions is scored against one or more reference texts.

5. The method of claim 4 wherein the one or more reference texts represent human generated content.

6. The method of claim 1 wherein the score is a composite score comprising multiple sub-scores, wherein each of the sub-scores indicates a performance measure and/or quality measure of the corresponding LLM which generates the summary description associated with the score.

7. The method of claim 6 wherein the score comprises at least one of a sub-score indicating a prompt response time of the LLM, a sub-score indicating conciseness of the summary description, a sub-score indicating a degree of hallucinations included in the summary description, a sub-score indicating a degree of deviating from a human-generated reference summary description, and a sub-score indicating a degree of offensive and/or hate speech reflected in the summary description.

8. The method of claim 6 wherein the score comprises at least one of a Recall-Oriented Understudy for Gisting Evaluation sub-score, a Bidirectional Encoder Representations from Transformers sub-score, a Bilingual Evaluation Understudy sub-score, a Hallucination sub-score, and a Toxicity sub-score.

9. The method of claim 1 wherein the summary description comprises a product and/or service description.

10. A computing system for data processing, the computing system comprising:
at least one processor;
at least one main memory coupled with the at least one processor; and
a network interface device operably associated with the at least one processor,
wherein the at least one main memory contains a plurality of program instructions that, when executed by the at least one processor, cause the at least one processor to perform operations comprising:
retrieving a description comprising a first description part consisting of structured data and a second description part consisting of unstructured data;
identifying textual named entities in the second description part using a Named Entity Recognition based algorithm;
merging the identified textual named entities into the structured data;
generating, based on the structured data including the textual named entities, a plurality of summary descriptions, wherein each summary description is generated using a Large Language Model (LLM) being distinct from another LLM-based algorithm from a plurality of LLMs;
determining a score for each one of the plurality of summary descriptions;
selecting one of the plurality of LLMs based on the score; and
generating further summary descriptions based on further descriptions using the selected LLM.

11. The computing system of claim 10 wherein the Named Entity Recognition based algorithm comprises Prompt Locating and Typing for Named Entity Recognition.

12. The computing system of claim 10 wherein the LLM is based on a Gemini-model and/or a Mistral-model and/or a Llama-model.

13. The computing system of claim 10 wherein the plurality of summary descriptions is scored against one or more reference texts.

14. The computing system of claim 13 wherein the one or more reference texts represent human generated content.

15. The computing system of claim 10 wherein the score is a composite score comprising multiple sub-scores, wherein each of the sub-scores indicates a performance measure and/or quality measure of the corresponding LLM which generates the summary description associated with the score.

16. The computing system of claim 15 wherein the score comprises at least one of a sub-score indicating a prompt response time of the LLM, a sub-score indicating conciseness of the summary description, a sub-score indicating a degree of hallucinations included in the summary description, a sub-score indicating a degree of deviating from a human-generated reference summary description, and a sub-score indicating a degree of offensive and/or hate speech reflected in the summary description.

17. The computing system of claim 6 wherein the score comprises at least one of a Recall-Oriented Understudy for Gisting Evaluation sub-score, a Bidirectional Encoder Representations from Transformers sub-score, a Bilingual Evaluation Understudy sub-score, a Hallucination sub-score, and a Toxicity sub-score.

18. The computing system of claim 10 wherein the summary description comprises a product and/or service description.

19. A computer program product comprising:
a non-transitory computer-readable storage medium; and
program code stored on the non-transitory computer-readable storage medium that, when executed by at least one processor, causes the at least one processor to perform operations comprising:
retrieving a description comprising a first description part consisting of structured data and a second description part consisting of unstructured data;
identifying textual named entities in the second description part using a Named Entity Recognition based algorithm;
merging the identified textual named entities into the structured data;
generating, based on the structured data including the textual named entities, a plurality of summary descriptions, wherein each summary description is generated using a Large Language Model (LLM) being distinct from another LLM-based algorithm from a plurality of LLMs;
determining a score for each one of the plurality of summary descriptions;
selecting one of the plurality of LLMs based on the score; and
generating further summary descriptions based on further descriptions using the selected LLM.
